(19) United States
(12) Patent Application Publication
(10) Pub. No.: US 2011/0284101 A1
(43) Pub. Date: Nov. 24, 2011

(54) ELECTRONICALLY REGULATABLE MIXING DEVICE FOR TAP WATER

(75) Inventors: Friedrich Thurau, Herscheid (DE); Lutz Lange, Luedenscheid (DE)

(73) Assignee: FLUEHS DREHTECHNIK GMBH, Luedenscheid (DE)

(21) Appl. No.: 13/138,178

(22) PCT Filed: Dec. 30, 2009
(86) PCT No.: PCT/DE2009/001826

§ 371 Date: Jul. 26, 2011

(30) Foreign Application Priority Data
Jan. 16, 2009 (DE) 20 2009 000 525.9

(51) Int. Cl. F16K 17/36

(52) U.S. Cl. 137/468

(57) ABSTRACT

The invention relates to a mixing device for tap water, comprising a mixing valve and a flow control valve that can each be actuated by a spindle and are arranged one behind the other. The device is characterized in that sensors (21, 22) are provided for determining the volume and temperature of the water flow, the sensors being connected to a control and regulating device used to adjust the volume and temperature of the water flow. A temperature sensor (22) is arranged in the flow control valve (4), for determining the temperature of the volume of water flow guided through the mixing valve (5).

The invention relates to an electronically regulatable mixing device for tap water, in accordance with the preamble of claim 1.

When supplying water, particularly in the kitchen and the bathroom, there is regularly a requirement of being able to set a defined water temperature as well as a defined water pressure. For setting the temperature, it is known to use thermostat mixers, which regulates the mixing ratio of a cold-water stream as well as a hot-water stream by way of a thermal element. In this connection, the thermocouple is disposed in such a manner that the water streams are influenced as a function of the thermal expansion of the element. The relative position of the thermocouple can be varied by way of an adjustment button, thereby making the desired water temperature adjustable. Setting of the water pressure takes place by way of a downstream flow control valve, with which the in-flow of the mixed water stream of the thermostat valve can be set. Setting regularly takes place by way of rotating or tilting devices. By means of mechanical effects, such as vibrations induced by the water through-flow, or by means of weight forces applied to the adjustment lever, however, adjustment by means of internal dynamics is often brought about, which has the result of a change in the actually applied temperature and/or the actually applied water pressure, and which can make readjustment of the parameters necessary at irregular time intervals.

Against the background of the state of the art, there is an increasing demand to be able to set the temperature and the volume stream of the water conveniently and reliably. This is where the present invention takes its start. The invention is based on the task of creating a mixing device for tap water that allows convenient regulation of water pressure and temperature. According to the invention, this task is accomplished by means of the characterizing part of claim 1.

With the invention, a mixing device for tap water is created, which allows convenient regulation of the water amount stream and temperature. For this purpose, an electronic control and regulation device is provided, which is connected with sensors for determining the applied water amount stream as well as the applied water temperature, and which guarantees a predetermined through-flow amount and temperature of the water amount stream on the basis of the measurement values of the sensors that are present, in each instance. In this connection, a temperature sensor for determining the temperature of the water amount stream passed in by way of the mixing valve is disposed in the multi-port valve. In this way, a temperature measurement close to use is brought about, thereby avoiding temperature impairments due to subsequent line paths. Preferably, the temperature sensor is disposed in the in-flow of the multi-port valve.

In a further development of the invention, the flow control valve is configured as a multi-port valve. In this way, it is additionally made possible to assign the water amount stream to one of multiple out-flows, as is required in bathroom fittings, for example, to switch between the tub in-flow and the shower in-flow.

In an embodiment of the invention, the multi-port valve is configured in such a manner that both the assignment of the out-flow to be supplied as well as the through-flow amount of the water amount stream can be set by way of the spindle. In this way, simple controllability of the valve is made possible.

In a further embodiment of the invention, the mixing valve is configured in such a manner that in the closed state of the mixing valve, mixing of the amount flows of the in-flow lines to which it is connected is prevented. In this way, back-flow of the amount stream of one in-flow line into the other, due to different pressure conditions that are applied, is prevented. A back-flow prevention mechanism that is usually provided for this purpose becomes unnecessary.

In a further development of the invention, the mixing valve and the flow control valve are connected with one another by way of a line in which a through-flow sensor for measuring the water amount stream is disposed. In this way, continuous measurement of the water amount stream made available by the mixing valve is made possible.

In a further development of the invention, the temperature sensor is disposed in the spindle of the multi-port valve. In this way, optimal positioning of the sensor in the water amount stream is achieved.

In an embodiment of the invention, the mixing valve is connected with a drive, by way of which it can be activated and which is connected with the control and regulation device. In this way, direct control by way of the control and regulation device is made possible. It is advantageous if the multi-port valve is also connected with a drive, by way of which it can be activated and which is connected with the control and regulation device.

In a further embodiment of the invention, at least one drive comprises an electric motor that drives a shaft that is connected with the spindle of the mixing valve or flow control valve by way of a gear mechanism. In this way, precise setting of the valves by way of the control and regulation device is made possible.

It is advantageous if both the mixing valve as well as the flow control valve have a head piece, through the center of which a spindle radially guided in it passes, and into which at least one window is introduced on the side, and that accommodates a pass-through disk with two pass-through openings on its side opposite the spindle, whereby the through-flow direction of the water stream in the flow control valve is opposite the through-flow direction in the mixing valve. In this way, parallel placement of the in-flow and out-flow lines is made possible. Furthermore, in this way upper valve parts that are identical, to a great extent, can be used, and thereby production and storage costs are reduced.

Other embodiments and further developments of the invention are indicated in the other dependent claims. An exemplary embodiment of the invention is shown in the drawing and will be described in detail in the following. The drawing shows:

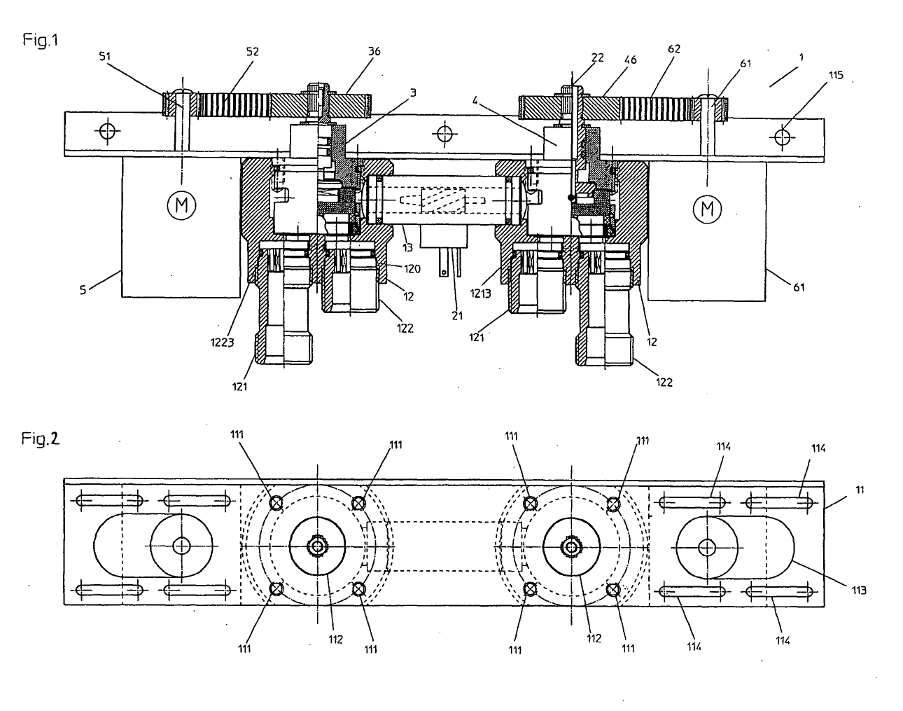

FIG. 1 the elevation of a mixing device in partial section;

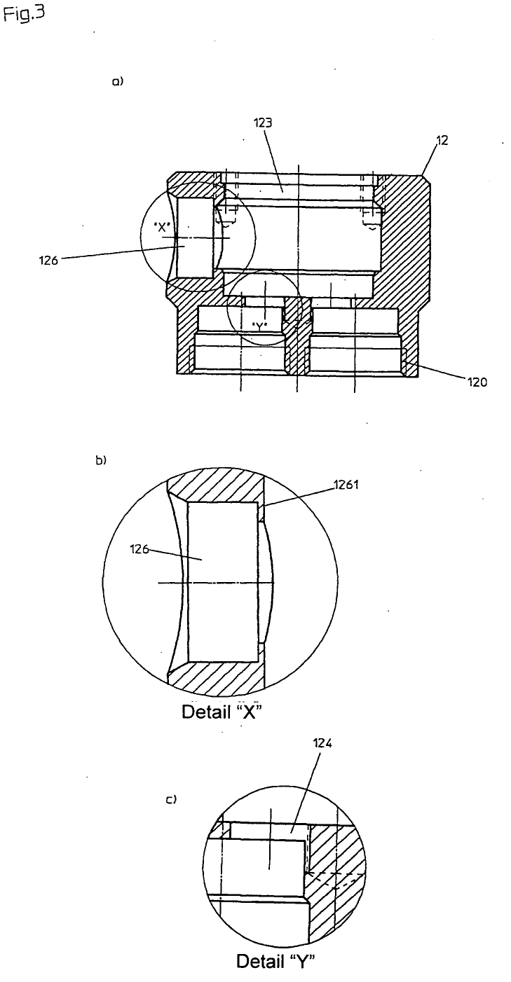

FIG. 2 the mixing device from FIG. 1 in a top view;

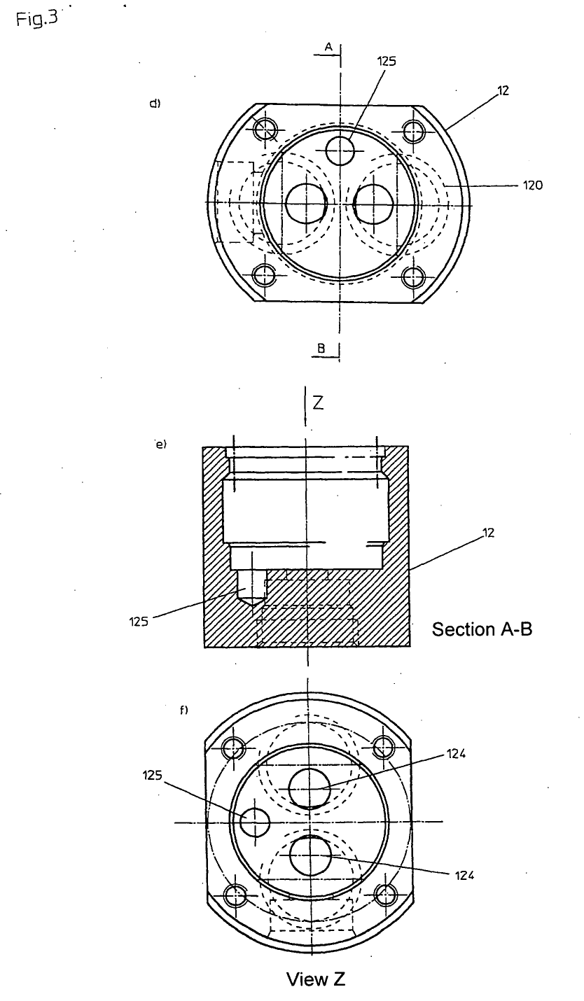

FIG. 3 the representation of the out-flow-side housing part of the mixing device from FIG. 1
a) in a sectional representation;
b) in a detail view “X” of the sectional representation from Figure a);
c) in a detail view “Y” of the sectional representation from Figure a);
d) in the view from above;
e) in a sectional representation along the line “A-B” from Figure d);
f) in the top view “Z,” the elevation from Figure e);

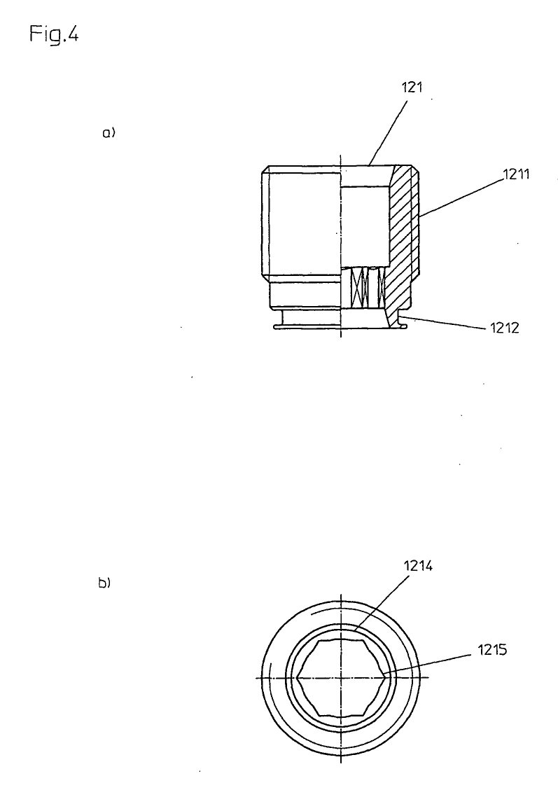

FIG. 4 the representation of the short connector piece of the housing part from FIG. 1
a) in partial section;
b) in the top view;

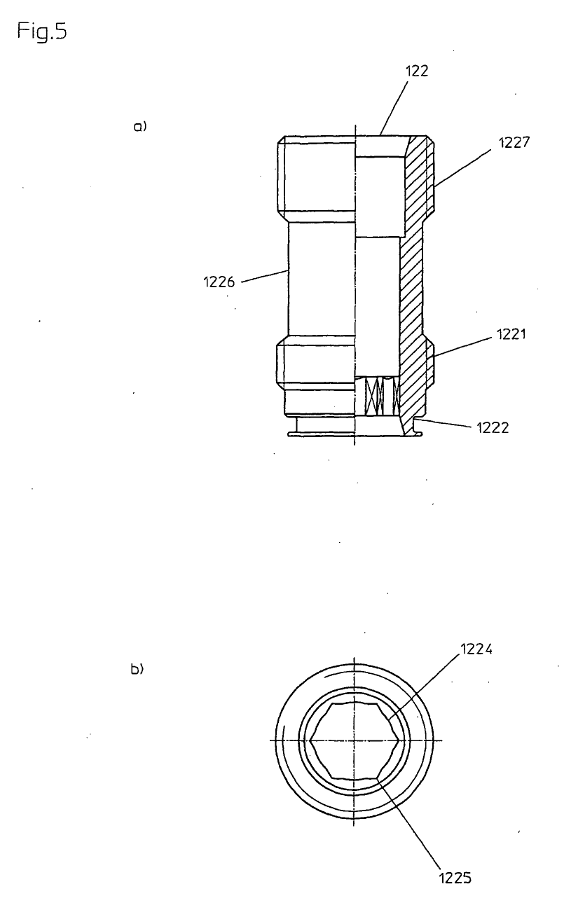

FIG. 5 the representation of the long connector piece of the out-flow-side housing part from FIG. 1
a) in partial section;
b) in the top view;

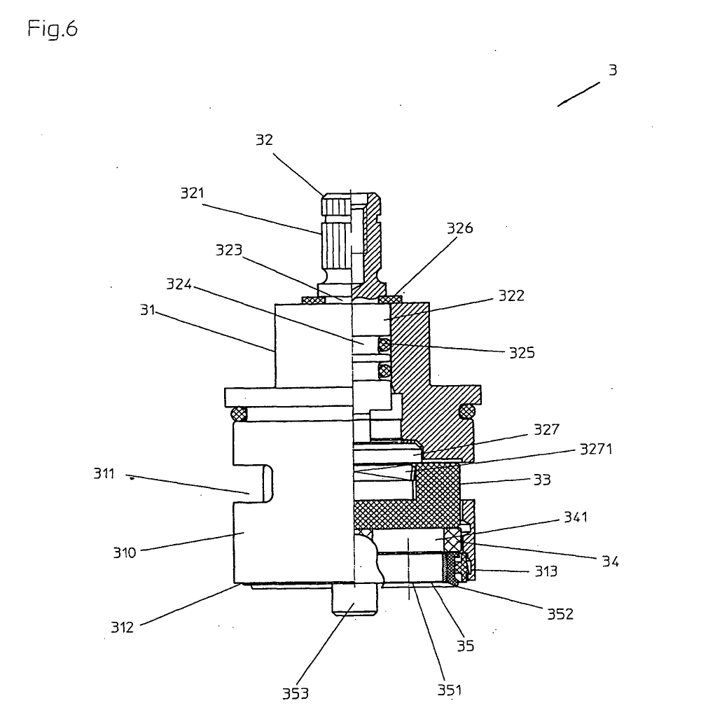

FIG. 6 the representation of the upper mixing valve part of the device from FIG. 1 in partial section;

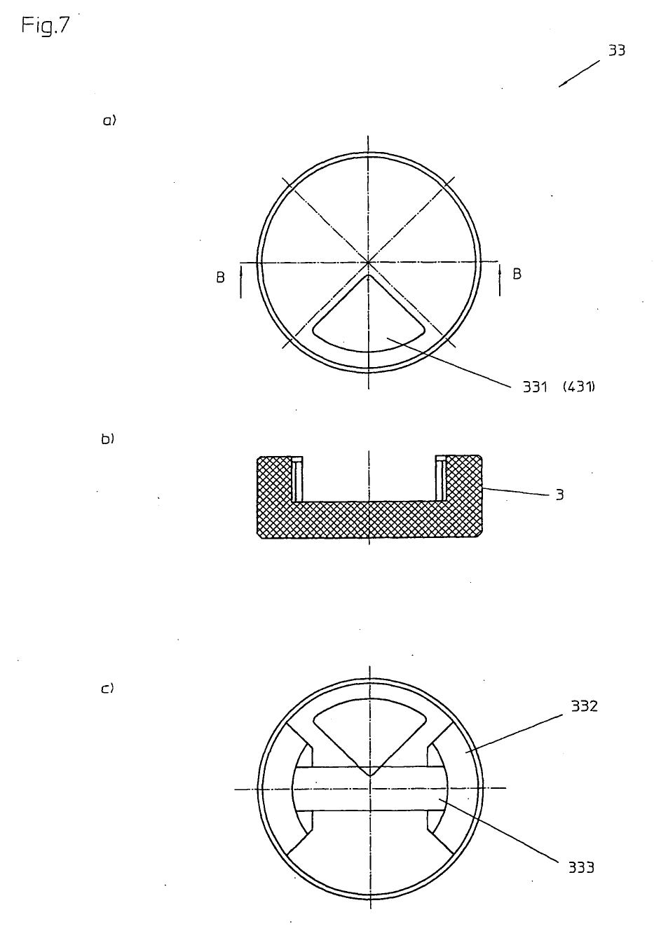

FIG. 7 the representation of a control disk of the upper mixing valve part from FIG. 6
a) in the view from the bottom;
b) in axial section;
c) in the top view;

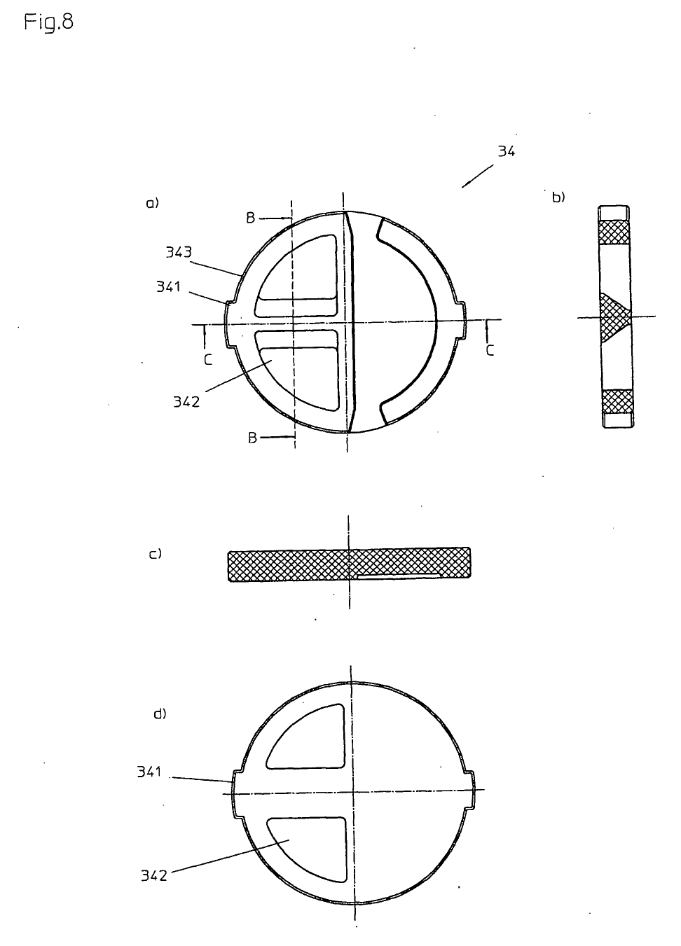

FIG. 8 the representation of the inlet disk of the upper mixing valve part from FIG. 6
a) in the top view;
b) in a sectional representation along the line B-B in Figure a);
c) in a sectional representation along the line C-C in Figure a);
d) in the view from the bottom;

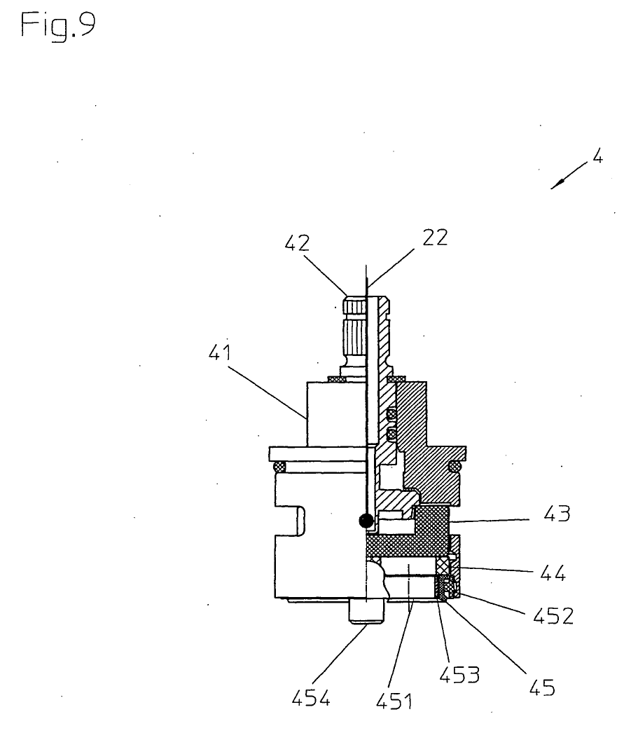

FIG. 9 the representation of the upper multi-port valve part of the from FIG. 1 in partial section, and

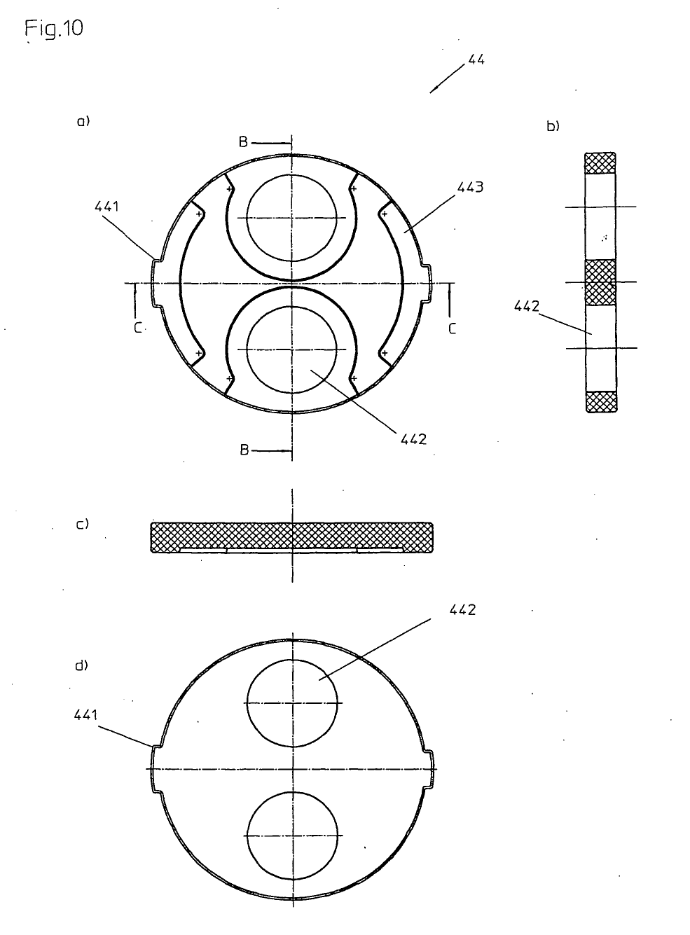

FIG. 10 the representation of the inlet disk of the upper multi-port valve part from FIG. 9
a) in the top view;
b) in a sectional representation along the line B-B in Figure a);
c) in a sectional representation along the line C-C in Figure a);
d) in the view from below.

The mixing device 1 selected as an exemplary embodiment comprises a rail 11 on which two housing parts 12 are disposed, next to one another, which parts are connected with one another by way of a line 13, in which a through-flow sensor 21 is disposed. The one housing part 12, on the inflow side, accommodates an upper mixing valve part 3 and is provided with two connector pieces 121, 122. The other housing part 12, on the outflow side, accommodates an upper multi-port valve part 4 and is also provided with two connector pieces 121, 122. Furthermore, two electric motors 5, 6 are provided for activation of the upper mixing valve part 3 and of the upper multi-port valve part 4, respectively.

In the exemplary embodiment, the rail 11 is configured as a rectangular metal sheet that is angled off at a right angle on one longitudinal side. Bores 111 for attaching the two housing parts 12 are made in the rail 11. In this connection, four bores 111, in each instance, are disposed in such a manner that they surround a circular recess 112 introduced in the center between them, uniformly spaced apart around it, which recess serves for passage of an upper valve part 3, 4. Towards both ends of the rail 11, an oblong recess 113 is introduced into it, in each instance, which recess serves for passage of the shaft 51, 61 of an electric motor 5, 6, and which recesses are flanked by four oblong holes 114, in each instance, for adjustable attachment of the electric motor 5, 6 on the rail 11. Furthermore, in the angled-off region of the rail 11, bores 115 for attaching the device 1 are provided.

The housing parts 12 are configured identically and are configured, in the exemplary embodiment, as essentially cylindrical hollow brass bodies. On its underside, facing away from the rail 11, two threaded bores 120 are introduced into the housing 12, into which bores the connector pieces 121, 122 are screwed. On its top, facing toward the rail 11, a bore 123 is introduced into the housing part 12, as a valve seat for accommodating an upper valve part 3, 4. Two through-flow bores 124 are introduced into the base of the bore 123, diametrically opposite one another, which bores open into the threaded bores 120. Furthermore, a dead-end bore 125 is disposed between the bores 124, in the base of the bore 123 serving as a valve seat.

On the side, a bore 126 is introduced into the housing part 12, which bore opens into the bore 123 serving as a valve seat. A step 1261 is formed on in the bore 126, which step serves as a stop for the line 13, which is provided with an O-ring 131 to provide a seal with regard to the housing part 12.

The connector pieces 121, 122 are configured in the manner of a pipe piece and serve for connecting in-flow and out-flow lines to the housing parts 12. The connector piece 121 is configured as a short connector piece and has an outside thread 1211 that corresponds with the inside thread of the threaded bore 120. In the exemplary embodiment, the outside thread 1211 is structured as a ½ inch thread.

On its end facing the rail 11, a groove 1212 for accommodating an O-ring 1213 is introduced into the connector piece 121. On the inside, a step 1214 is formed on in the connector piece 121, in the region of the groove 1212, into which step six notches 1215, spaced at uniform intervals around the circumference, are introduced.

The connector piece 122, which is configured to be longer as compared with the connector piece 121, also has an outside thread 1221 that corresponds with an inside thread of the threaded bore 120 of the housing 12 and that is followed by a groove 1222 for accommodating an O-ring 1223. Likewise, a step 1224 is disposed on the inside, which step is provided with six notches 1225 spaced uniformly apart from one another. The outside thread 1221 is followed by a cylindrical section 1226 that makes a transition into a second outside thread 1227. In the exemplary embodiment, the two outside threads 1221, 1227 are structured as ½ inch threads.

The upper mixing valve part 3 selected as an exemplary embodiment has a head piece 31 through the center of which a spindle 32, radially guided in it, passes. A control disk 33 is connected with the spindle 32, with shape fit, and is radially guided in the head piece 31. On the side of the control disk 33 facing away from the spindle 32, an inlet disk 34 is provided in the head piece 31, which disk is followed by a connector disk 35, which comes to rest against the valve seat of the housing part 12 formed by the bore 123.

The head piece 31 consists of a symmetrical hollow body whose two face sides are open. On its side facing the housing part 12, the head piece 31 has a sleeve-like part 310. Two passage windows 311 are provided in the part 310.

After penetration into the housing part 12, a collar 312 of the head piece 31 lies on the base of the bore 123 serving as a valve seat. An undercut 313 is disposed in the sleeve-like part 310, on the inside, in the region of the collar 312.

The spindle 32 is structured to be essentially solid. It is structured as an outside polygon 321 on its face side, on the outside, acing away from the head piece 31. Subsequently, a cylindrical surface 322 is provided on the outside of the spindle 32, with which surface the spindle 32 is radially guided in the head piece 31. A recess 323 is provided between the cylindrical surface 322 and the outside polygon 321, into which recess a shaft-securing device 326 in the form of a circlip is resiliently inserted. The shaft-securing device 326 prevents penetration of the spindle 32 into the head piece 31 beyond the intended dimension. Furthermore, two ring grooves 324 are introduced into the cylindrical surface 322, which grooves accommodate O-rings 325. On the side of the spindle 32 opposite the outside polygon 321, a disk 327 is formed on, which has a catch 3271 on its side facing the housing part 12.

The control disk 33 is essentially configured as a circular disk from which a sector 331 has been removed. In the exemplary embodiment, the sector 331 has an angle of approximately 90°. On its side facing the spindle 32, the control disk 3 has two arc-shaped steps 332 that are disposed diametrically opposite one another. In the assembled state, the ring-shaped step 332 surrounds the catch 3271 of the spindle 32. Recesses 333 are configured on the steps 332, into which recesses the catch 3271 engages (see FIG. 7c)).

The inlet disk 34 is shown in FIG. 8. On its circumference, it has two projections 341 that lie diametrically opposite one another. With the projections 341, the disk 34 engages into recesses that are provided in the sleeve-shaped part 310 of the head piece 31 for this purpose. The inlet disk 34 is therefore disposed in the head piece 31 so as to rotate with it. The inlet disk has two sectors 342 that are disposed next to one another, which correspond with the sector 331 of the control disk 33. On the outside, crosspiece-like contours 343 are formed onto the underside of the inlet disk 34, facing away from the control disk 33, around the sectors 342 and in the region of the projections 341.

In the exemplary embodiment, the connector disk 35 is produced from plastic. On its circumference, it also has two projections that lie diametrically opposite one another, with which projections it engages into recesses that are provided in the sleeve-shaped part 310 of the head piece 31 for this purpose. It is thereby fixed in the head piece 31 so as to rotate with it. The connector disk 35 has two passage openings 351 disposed next to one another, which openings can be positioned to cover the two sectors 342 of the inlet disk 34, and in which a lip gasket 352, in each instance, is disposed to form a seal with regard to the valve seat of the housing part 12 formed by the bore 123. Furthermore, the connector disk 35 has a cylindrical pin 353 on its underside, facing away from the inlet disk 34, which pin corresponds with the dead-end bore 125 of the housing part 12 and serves for positioning of the upper mixing valve part 3 in the housing part 12.

The upper multi-port valve part 4 is structured to be identical, to a great extent, to the upper mixing valve part 3. It has an identical head piece 41 through the center of which a spindle 42, radially guided by it, passes. In addition, a thermal sensor 22 for continuous measurement of the temperature of the water fed in by the upper mixing valve part 3 is disposed in the spindle 42 (see FIG. 9). A control disk 43 is also connected with the spindle 42, with shape fit, and radially guided in the head piece 41. Likewise, an inlet disk 44 is provided in the head piece 41, followed by a connector disk 45 that comes to lie against the valve seat of the housing part 12 formed by the bore 123. The multi-port valve 4 differs from the mixing valve 3 only by the inlet disk 44 and the connector disk 45, which are used in a different way.

The inlet disk 44 of the upper multi-port valve part 4 is shown in FIG. 10. In contrast to the inlet disk 34 of the upper mixing valve part 3, it has two circular passage openings 442, disposed diametrically opposite one another. Crosspiece-like contours 443 are formed on, on the underside of the inlet disk 44 that faces the connector disk 45, on the outside, surrounding the passage openings 442, and in the region of the projections 441 formed on at the side.

In contrast to the connector disk 35 of the upper mixing valve part 3, the connector disk 45 has two circular passage openings 451 disposed diametrically opposite one another, which align with the passage openings 442 of the inlet disk 44. A crosspiece—not shown—for accommodating a lip gasket 452 is formed on in the passage openings 442, in each instance, on the inside circumference. The lip gasket 452 is held in the passage opening 451 by way of an introduced support ring 453. In the installed state, the lips of the lip gasket 452 lie against the inlet disk 44 as well as against the base of the bore 123 of the housing part 12 serving as a valve seat, forming a seal. Furthermore, the connector disk 45 has a cylindrical pin 454 on its underside, facing away from the inlet disk 44, which pin corresponds with the dead-end bore 125 of the housing part 12 and serves for positioning the upper multi-port valve part 4 in the housing part 12.

The housing parts 2 are attached to the rail 11 by means of screws—not shown—that are passed through the bores 111 of the rail 11, in such a manner that the upper valve part 3, 4 introduced into the housing part 12, in each instance, projects through a recess 112 of the rail 11 with its head piece 31, 41. The housing parts 12 are connected with one another by way of the line 13, which lies against the step 1261 of a housing part 12 with one end, in each instance. On its side lying opposite the line 13, an electric motor 5, 6 is disposed on each housing part 12, in each instance, which motor is connected with the rail 11 by means of screws—not shown—that are passed through the oblong holes 114 of the rail 11, in such a manner that the motor shaft 51, 61 of the motor 5, 6, in each instance, projects through the recess 113 of the rail 11. The motors 5, 6 can be adjusted along the longitudinal axis of the recesses 113 by way of the oblong holes 114. On the side of the rail 11 lying opposite the motors 5, 6, the shafts 51, 61 of the motors 5, 6 are connected with a gearwheel 52, 62, which stands in engagement with a gearwheel 36, 46, which in turn is connected with the outside square of the spindle 32, 42 of the upper valve parts 3, 4. Rotation of the shaft 51, 61 of a motor 5, 6 is thereby transferred to a spindle 32, 42 of an upper valve part 3, 4, in the opposite direction, and this part can thereby be operated.

A control and regulation device—not shown—is connected with the through-flow sensor 21 and with the temperature sensor 22 on the input side. Furthermore, an input unit—not shown—is disposed on the input side, by means of which unit user-side defaults with regard to water temperature, the water amount stream, as well as the water out-flow (tub/shower) can be set. On the output side, the control and regulation device—not shown—is electronically connected with the motors 5, 6.

In the installed state, the mixing device is connected, on the in-flow side, with a cold-water in-flow by way of the connector piece 121, and with a hot-water in-flow by way of the connector piece 122. The out-flow-side housing part is connected with a tap of a bathtub by way of the connector piece 121 and with the in-flow of a shower head by way of the connector piece 122. After the desired water temperature, water amount, and the desired out-flow, in other words the selection between tap and tub or shower head, are input, the upper valve parts 3, 4 are set by way of the motors 5, 6, in such a manner that the measurement values transmitted by way of the sensors 21, 22 agree with the selected default data. As this is done, the desired water temperature is set by way of the upper mixing valve part 3, which temperature is continuously measured in the in-flow of the upper multi-port valve part 4, by way of the sensor 22. For one thing, assignment of the water amount stream made available by the upper mixing valve part 3 to the bathtub or to the shower takes place by way of the upper multi-port valve part 4; for another, a change in the water amount stream is made possible by way of the upper multi-port valve part 4, by setting the coverage of the sector 431 of the control disk 43 with the passage opening 442 of the inlet disk 44 or the passage opening 451 of the connector disk 45 that corresponds with it. The water amount stream achieved, in each instance, is reported to the control and regulation device—not shown—by way of the through-flow sensor 21, which device undertakes re-regulation of the upper multi-port valve part 4 by way of the motor 6, in case of a deviation from the set default value. Likewise, re-regulation of the upper mixing valve part 3 takes place by way of the motor 5, in case of deviations between the real value measured by the temperature sensor 22 and the pre-set temperature reference value.

1. Mixing device for tap water, comprising a mixing valve and a flow control valve, which can be activated by way of a spindle, in each instance, and which are disposed in series one behind the other, wherein both the mixing valve (3) and the flow control valve (4) have a head piece (31, 41) through the center of which a spindle (32, 42) radially guided by it passes, and into which at least one window (311) is introduced on the side, and which accommodates an inlet disk (34, 44) having two passage openings (351, 451) on its side opposite the spindle (32, 42), whereby the through-flow direction of the water amount stream in the flow control valve (4) is opposite the through-flow direction in the mixing valve (3) and wherein sensors (21, 22) for determining the water amount stream and temperature are provided, which are connected with a control and regulation device by way of which the through-flow amount and temperature of the water amount stream can be set, whereby a temperature sensor (22) for determining the temperature of the water amount stream supplied by way of the mixing valve (5) is disposed in the flow control valve (4).

2. Device according to claim 1, wherein the flow control valve is configured as a multi-port valve (4).

3. Device according to claim 2, wherein the multi-port valve (4) is configured in such a manner that not only the assignment of the out-flow to be supplied but also the through-flow amount of the water amount stream can be set by way of the spindle (42).

4. Device according to claim 1, wherein the mixing valve is structured in such a manner that in the closed state of the mixing valve, mixing of the amount streams of the in-flow lines to which it is connected is prevented.

5. Device according to claim 1, wherein mixing valve (3) and flow control valve (4) are connected with one another by way of a line (13), in which line a through-flow sensor (21) for measuring the water amount stream is disposed.

6. Device according to claim 1, wherein the temperature sensor (22) is disposed in the in-flow of the flow control valve (4).

7. Device according to claim 6, wherein the temperature sensor (22) is disposed in the spindle (42) of the flow control valve (4).

8. Device according to claim 1, wherein the mixing valve (3) is connected with a drive (5), by way of which it can be activated and which is connected with the control and regulation device.

9. Device according to claim 1, wherein the flow control valve (4) is connected with a drive (6), by way of which it can be activated and which is connected with the control and regulation device.

10. Device according to claim 8, wherein at least one drive (5, 6) comprises an electric motor that drives a shaft (51, 61) that is connected with the spindle (32, 42) of the mixing valve (3) or flow control valve (4), respectively, by way of a gear mechanism (52, 62).

11. (canceled)
